(19) United States
(12) Patent Application Publication
(10) Pub. No.: US 2011/0296523 A1
(43) Pub. Date: Dec. 1, 2011

(54) ACCESS CONTROL MANAGEMENT MAPPING RESOURCE/ACTION PAIRS TO PRINCIPALS

(75) Inventors: Stuart Edward Schechter, Kirkland, WA (US); Robert Wilson Reeder, Seattle, WA (US)

(73) Assignee: MICROSOFT CORPORATION, Redmond, WA (US)

(21) Appl. No.: 12/788,245

(22) Filed: May 26, 2010

(51) Int. Cl. G06F 21/00; G06F 3/00

(52) U.S. Cl. 726/21

(57) ABSTRACT

The access control management technique described herein manages access control to one or more resources. Rather than mapping individuals or groups to permissions, the technique maps each permission (the right to perform an action on a resource) to the list of authorized principals (the users and groups authorized to perform the action on the resource). These lists are written in text form just as one would write the list of recipients (individuals and groups) of an email composition window. The technique also provides various operations to allow a user to manage the list of authorized principals and the authorizations assigned to a principal to access the resource/action pair.

### BACKGROUND

Access control policies specify which user can or cannot access a resource such as a folder, file, object, or medical data on a computing device. Most existing access control management policies are specified using Access Control Lists (ACLs), which contain lists of rules written in terms of users or groups. An ACL, with respect to a computer file system, is a list of permissions attached to an object. For example, in Microsoft® Corporation's Windows NT operating system an ACL is a data structure containing entries that specify individual user or group rights to specific system objects such as programs, processes or files. These entries are known as access control entries (ACEs). Each accessible object contains an identifier to its ACL. An ACL specifies which users are granted access to resources, as well as what operations are allowed on given resources. Each entry in a typical ACL specifies a resource and an operation or action. Users typically have difficulty comprehending, remembering, and modifying access control policies when expressed using list-of-rules interfaces.

Other interfaces to ACLs have also been used. For example, an expandable grid has been used to make access control policies easier to work with. This grid displays resources such as, for example, file names, in rows and user names as columns. In the intersection of each row and column the authorization level is indicated for the associated resource and user. Some email programs implicitly manage the set of individuals who can read an email through the use of the TO, CC (copy to), and BCC (blind copy to) text boxes.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The access control management technique described herein provides a user interface to manage access by individuals or groups to one or more resources. The technique maps each resource/action pair to a corresponding list of one or more authorized principals (e.g., a person or group) that are authorized to perform the action on the resource of the resource/action pair. A resource might be, for example, a folder, file, object, or other data element. An action might be, for example, a read, write or delete authorization. The technique displays the names of the authorized principals mapped to each resource/action pair on a display device of a computing device and allows a user to manipulate (e.g., add, delete) the authorized principals for the resource/action pairs. In addition, in one embodiment, the access control management technique maps resource/role pairs to a list of authorized principals. In this case a role is a set of actions, vice a single action.

Embodiments of the access control management technique can have many features. For example, one embodiment uses an editable text box displayed on a display to manage a list of principals (users and groups) permitted to perform an action on a resource. In one embodiment, the technique also allows a minus operator that allows a user to remove the authorization from individuals in a list (e.g., remove the principals from the list of authorized individuals), such as is needed when including a large group but excluding one member. Another embodiment of the technique displays textual representations of levels of groups that expand and contract inline for as many levels as the groups are deep. Yet another embodiment of the technique calculates and displays a heuristic to encourage a user to create new groups when it appears doing so would simplify access control policy management. Yet another embodiment of the technique allows a user to verify permissions and displays visual cues (e.g., a strikethrough) to indicate that a principal, while present in a list of authorized users, will not actually have permission to access or modify a resource. Additionally, one embodiment of the technique provides a method for translating existing access control list rules into the format used by the technique, mapping resource/action pairs to a list of principals. Lastly, one embodiment of the technique provides for the presentation of inherited permissions inline with custom permissions, using formatting or an indicator to differentiate user-specified permissions from inherited permissions.

### DESCRIPTION OF THE DRAWINGS

The specific features, aspects, and advantages of the disclosure will become better understood with regard to the following description, appended claims, and accompanying drawings where:

FIG. 1 is an exemplary architecture for employing one exemplary embodiment of the access control management technique described herein.

FIG. 2 depicts a flow diagram of an exemplary process for employing one embodiment of the access control management technique.

FIG. 3 depicts a flow diagram of another exemplary process for employing one embodiment of the access control management technique.

FIG. 4 depicts one exemplary User Interface (UI) of one embodiment of the access control management technique.

FIG. 5 depicts another exemplary UI of one embodiment of the access control management technique.

FIG. 6 is a schematic of an exemplary computing device which can be used to practice the access control management technique.

### DETAILED DESCRIPTION

In the following description of the access control management technique, reference is made to the accompanying drawings, which form a part thereof, and which show by way of illustration examples by which the access control management technique described herein may be practiced. It is to be understood that other embodiments may be utilized and structural changes may be made without departing from the scope of the claimed subject matter.

1.0 Access Control Management Technique

The following sections provide an overview of the access control management technique, as well as an exemplary architecture and processes for employing the technique. Details of features available in various embodiments of the technique, as well as exemplary layouts of user interfaces of the technique, are also provided.

1.1 Overview of the Technique

The access control management technique described herein manages access control to one or more resources. For example, a resource could be a folder, a file, an image, a web page or any other type of data stored on a computing device or some other type of storage device. These resources are paired to allowable actions on each resource. For example, an allowable action might be the authorization to read, delete or write to the file or resource. The technique maps to each resource/action pair a corresponding list of authorized principals that are authorized to perform the action on the resource of the resource/action pair. The authorized principals could be, for example, a person or a group of people. The technique displays the names of the authorized principals mapped to each resource/action pair on a display device of the computing device. The technique also allows a user to manipulate and change the authorized principals mapped to each resource/action pair and to take other actions to manage access.

Rather than mapping individuals or groups to permissions or roles, the technique maps each permission (the right to perform an action on a resource) or role (a bundle of permissions) to the list of authorized principals (the users and groups authorized to perform the action or set of actions on the resource). These lists are written in text form as one would write the list of recipients (individuals and groups) of an email in an email composition window. The technique also allows a user to delete an individual from the list of authorized principals using a minus sign operator and provides a visual indication (e.g., a strikethrough) that the individual has been deleted from the group. This might be a useful feature when including a large group as authorized principals, but excluding one member.

Embodiments of the access control management technique described herein can have many other features that make access management more straightforward to a user. One embodiment of the technique uses an editable text box to manage a list of principals (users and groups) permitted to perform an action on a resource. Additionally textual representations of groups that expand and contract inline for as many levels as the groups are deep can be employed. One embodiment of the technique includes a heuristic to encourage users to create new groups. Another embodiment employs a method for translating existing access control list rules into the resource/action/list of principals, as well as a mechanism that allows the user to verify the permissions for a given principal. These and other features and capabilities will be discussed in greater detail in Section 1.4.

1.2 Exemplary Architecture.

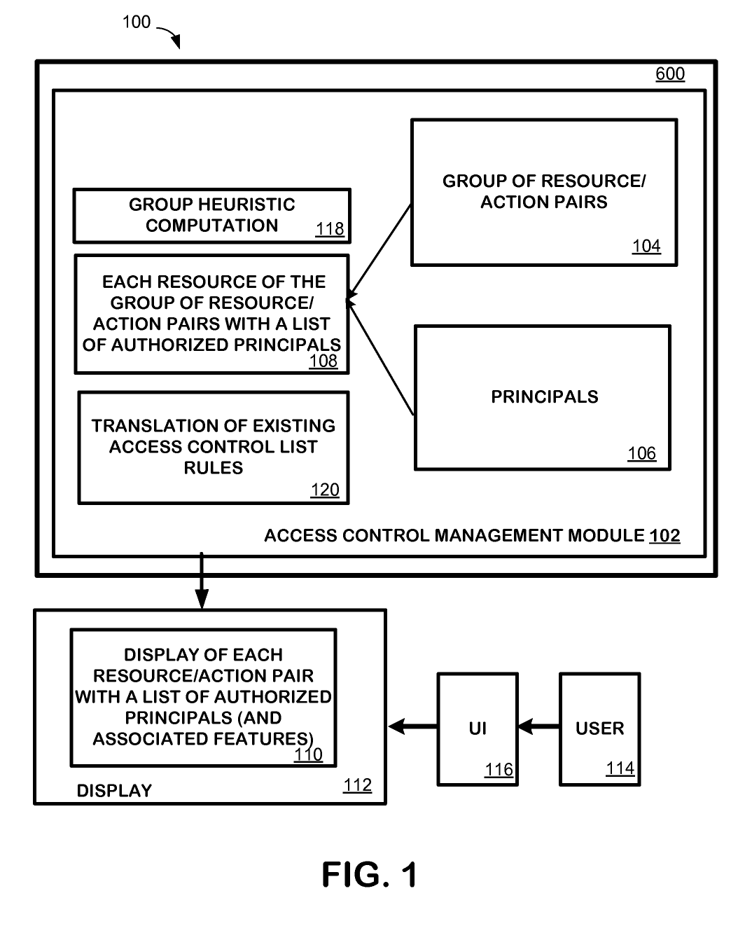

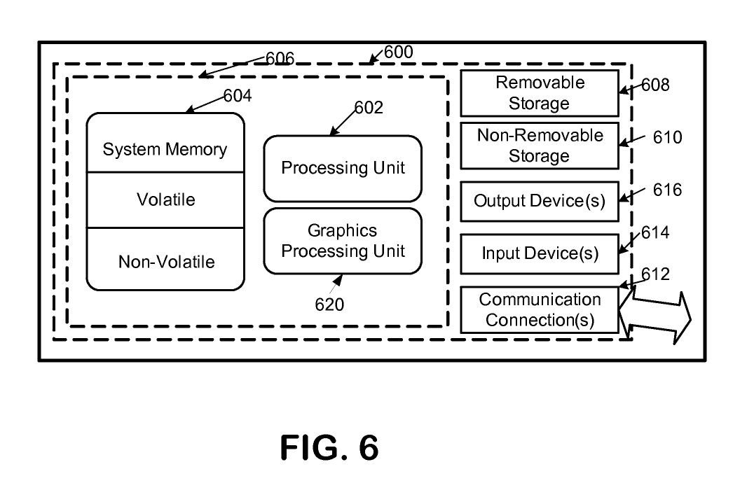

FIG. 1 provides an exemplary architecture 100 for employing one embodiment of the access control management technique. As shown in FIG. 1, the architecture 100 employs an access control management module 102 that resides on a computing device 600, such as will be discussed in greater detail with respect to FIG. 6.

In one embodiment, the architecture 100 includes a group of resource/action pairs 104. These resource/action pairs include a resource (e.g., a file, folder, image, document and so on), as well as a corresponding action that can be taken on the resource (e.g., read, write, delete, and so on). A list of one or more authorized principals 106, authorized to perform a corresponding action of each resource/action pair, is mapped to the resource/action pair in a mapping module 108. For example, these resources can be an individual or a group of individuals that can perform the action on the resource. The mapped list of authorized principals for each resource/action pair 108 can be displayed on a display device 112 of the computing device 600. More specifically, the name of each authorized principal can be displayed in text form next to the corresponding resource/action pair on the display device 112. A user 114 can manipulate the list of one or more authorized principals 104 with an input device in order to manage the authorization a principal has on a resource of a given resource/action pair using a User Interface (UI) 116. For example, a user 112 can delete one or more authorized principals 108 (that are authorized to perform an action on a resource) from the list of authorized principals. For example, the user 114 can remove an authorization from an individual by typing a minus operation next to the individual using a keyboard or other input device (using the UI 116).

Additionally, in one embodiment of the technique, the textual representations of authorized principals can expand and contract inline for as many levels as there are levels of groups of users.

The exemplary architecture 100 also can include a translation module 120 for translating existing access control policies into a format compatible with the technique. This is discussed in greater detail in Section 1.4.5.

The embodiment also includes a group heuristic computation module 118 that computes a heuristic for when a new group of authorized principals should be created. This is discussed in greater detail in Section 1.4.3.

1.3 Exemplary Processes Employed by the Access Control Management Technique.

The following paragraphs provide descriptions of exemplary processes for employing the access control management technique. It should be understood that in some cases the order of actions can be interchanged, and in some cases some of the actions may even be omitted.

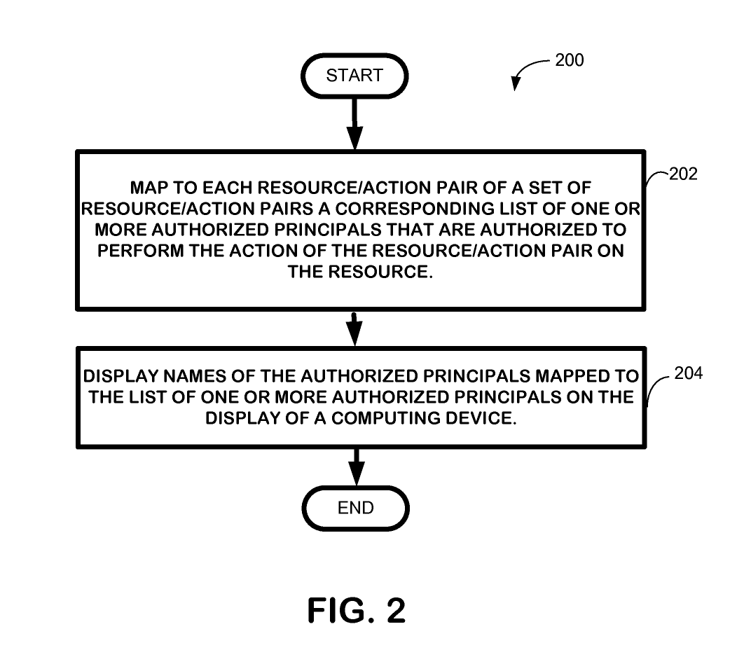

FIG. 2 depicts an exemplary computer-implemented process 200 for controlling access to computer resources. As shown in block 202, the technique maps to each resource/action pair of a set of resource/action pairs a corresponding list of one or more authorized principals that are authorized to perform the action of the resource/action pair on the resource. The names of the authorized principals mapped to each resource/action pair are displayed on a display of the computing device, as shown in block 204.

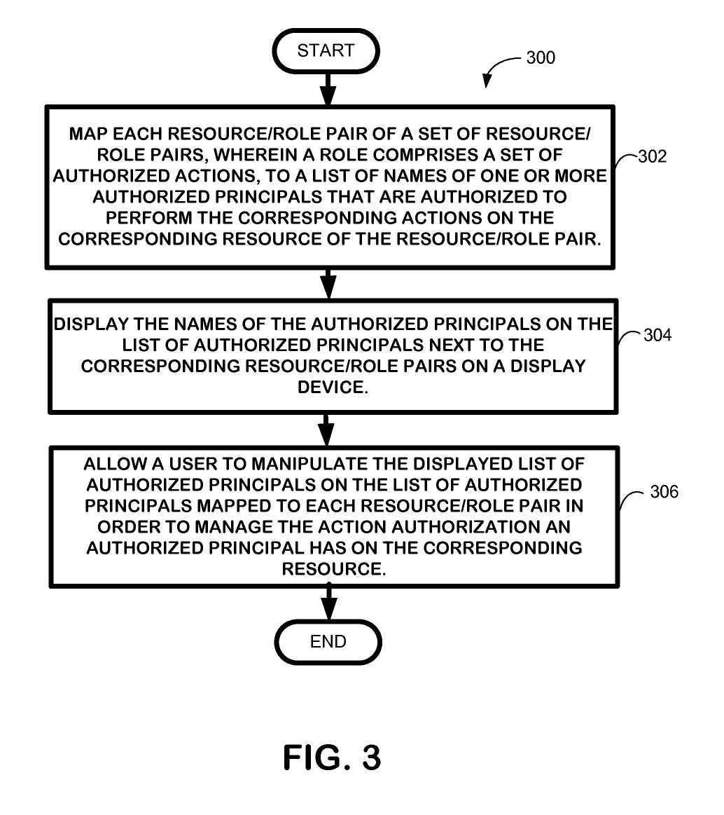

FIG. 3 depicts another exemplary computer-implemented process 300 for managing access control. In this embodiment, each resource/role pair of a set of resource/role pairs, wherein a role is a set of authorized actions, is mapped to a list of the names of one or more authorized principals that are authorized to perform the corresponding actions of the resource/role pair on the corresponding resource of the resource/role pair, as shown in block 302. The names of the authorized principals are displayed next to the corresponding resource/role pairs on a display device of the computing device, as shown in block 304. A user is allowed to manipulate the displayed names of authorized principals mapped to each resource/role pair in order to manage the level of access and the actions principals may take on the resources, as shown in block 306.

1.4 Details and Features of Various Exemplary Embodiments of the Access Control Management Technique.

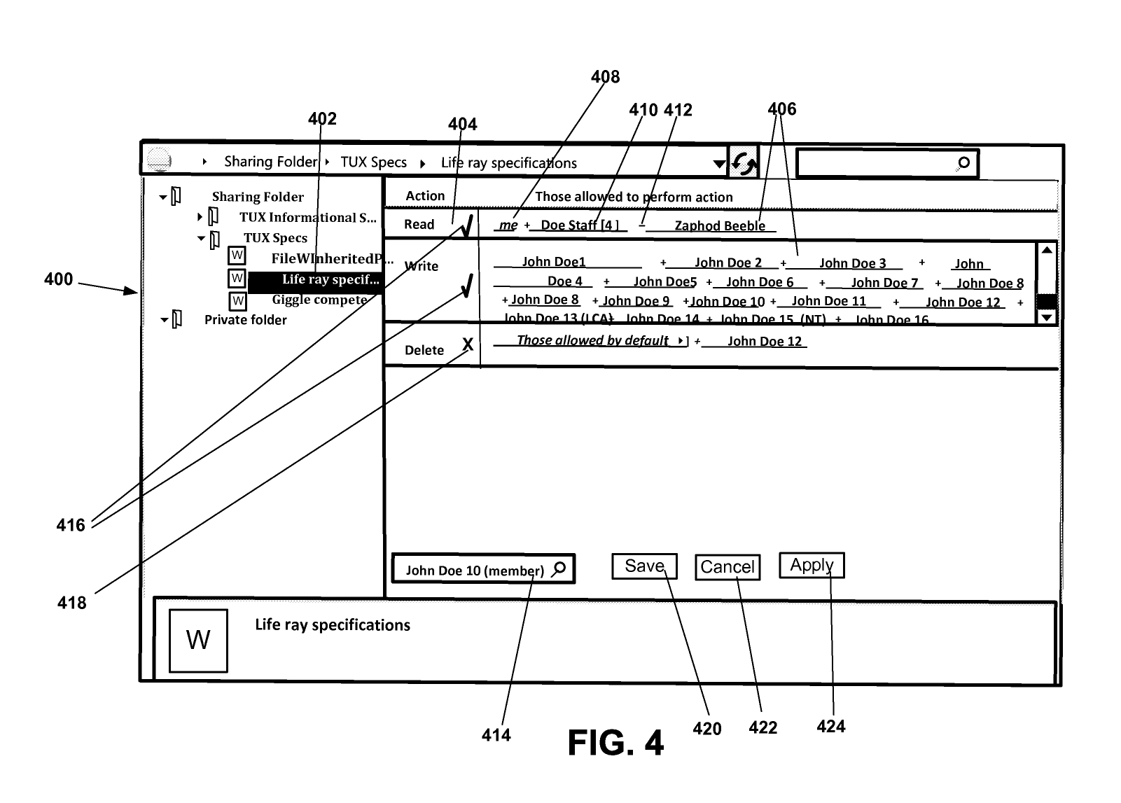

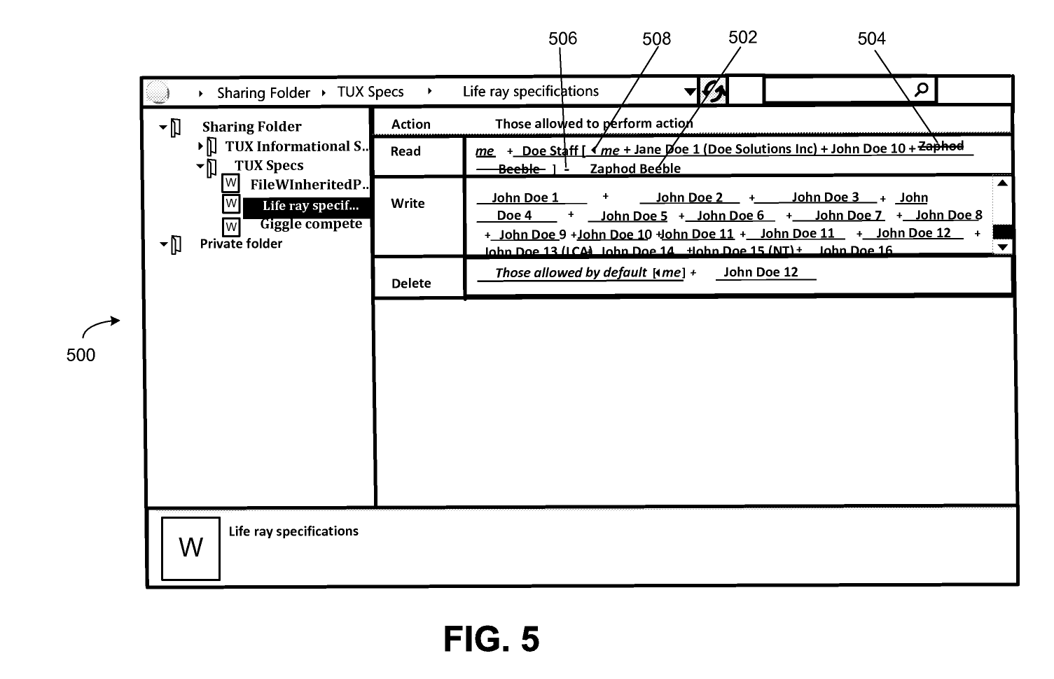

An exemplary architecture and exemplary processes having been provided, the following paragraphs provide details of various features of the access control management technique. The following discussion sometimes refers to FIGS. 4 and 5, which provide exemplary Uls employed in some embodiments of the access management control technique.

Embodiments of the access control management technique described herein can have the following features, many of which are displayed on the display of the computing device, as previously mentioned. As shown in FIG. 4, the technique, in one embodiment, has a UI 400 that displays the resource 402/action 404 pairs, along with each corresponding list of authorized principals 406. Other features of various embodiments of the technique are as follows:
An editable text box 408 is displayed to manage the list of principals 406 (users and groups) permitted to perform an action 404 on a resource 402 (or, more generally, display the permissions associated with a role such as “reader” or “contributor”).
Textual representations of groups 410 are displayed that expand and contract inline for as many levels as the groups are deep. In one embodiment of the technique, group names remain present even when expanded. FIG. 5, 502 shows an expansion of the group 410 of FIG. 4.
A heuristic may also be employed to encourage users to create new groups when it appears doing so would simplify access control management. For example, when the product of the number of users who might form a specific group times the number of times this set of users appear together in existing policies exceeds a specified threshold, a new group may be recommended to a user. A new group may be recommended to a user by simply presenting “groups to create” after sorting all possible groups by this threshold. This will be discussed in greater detail in Section 1.4.3.
As shown in FIG. 4, one embodiment of the technique makes use of a minus sign operation 412 to remove principals from a list of users and groups that are authorized to perform an action on the corresponding resource (e.g., file).
The technique in some embodiments also employs the use of visual cues (e.g. a strikethrough), as shown in FIG. 5, 504, to indicate that a principal, while present in the list, will not actually have permission (as will occur when a minus sign later in the list removes the principal) to perform an action on a resource.
The technique further can include a method for translating existing access control list rules into the list of principals configuration. This will be described in more detail in Section 1.4.5.
In one embodiment the technique provides for a mechanism that allows the user to verify the permissions (granted or not) for a given principal. The mechanism provides a cue that illustrates the part of the policy in which the principal is either granted or denied permission. This will be discussed in greater detail in Section 1.4.6.
In one embodiment of the technique, the technique can provide for the presentation of inherited permissions inline with custom permissions, using formatting or indicator to differentiate file/folder-specific permissions from inherited permissions. This is discussed in greater detail in Section 1.4.7.

1.4.1 Editable Text Box to Manage List of Principals

As shown in FIG. 4, one embodiment of the access control management technique uses an editable text box 408 to manage a list of principals (users and groups) 406 permitted to perform an action 404 on a resource 402.

In one embodiment, a user can use an input device such a keyboard to type a principal's name or enter it into a search box 414 to select a certain principal. Once a principal has been selected, an indicator (e.g., the check mark 416) appears in the action entry for a row if the principal has permission to perform the action in the row. A different indicator (e.g., an “X” 418) appears if the principal does not have permission. A third indicator (e.g., a dash) appears if the principal is a group and that principal is in the group descriptor but subject to some exclusions. A user can edit the principals directly on the display or by right clicking to bring up a menu of editing choices. Save 420, cancel 422 and apply 424 buttons allow changes to be saved, applied and cancelled, respectively. In this manner, the technique allows the user to view and edit the authorizations given to both individual users and groups.

1.4.2 Textual Representation of Groups

As shown in FIG. 4, one embodiment of the access control management technique employs textual representations of groups 410 that expand and contract inline for as many levels as the groups are deep, but group names remain present even when expanded. A single underline encompasses a group 410 and its members, even when the membership is expanded. In one embodiment of the technique, the set of group members are preceded by a left-pointing triangle ( [symbol] ) as shown in FIG. 5, 508, in place of the right-pointing one, which can be used to recompress the group so that only the number of members, and not the names of the members, is shown.

1.4.3 Group Creation Heuristic

One embodiment of the access control management technique employs a heuristic to encourage users to create new groups when it appears doing so would simplify policy management. For example, when the product of the number of users who might form a specific group times the number of times this set of users appear together in existing policies exceeds a specified threshold, one embodiment of the access control management technique recommends a new group (or optionally creates it). Or, in another embodiment, the technique recommends a new group by sorting all possible groups by this metric of potential group desirability. Another embodiment of the technique employs a process for identifying, tracking, and scoring (via the metric) candidate new groups. For example, the pseudo code for one embodiment of this process is as follows:

For n rules, each of which have a list of principals, there are m<=n unique sets of principals in those rules,

Create a table of the following triple for each unique set of principals (set of principals, occurrences of the set of principals, score), keeping an index based on the set of principals (e.g., using a hash table where the index is based on the score). The score is equal to the size of the set of principals (e.g., number of principals, groups not expanded) times the number of occurrences.

Walk through all existing rules in the list of n rules and add the set of principals in each rule.

When a rule is modified or added, update the table.

Sort the table based on score, from highest to lowest, to look for potential new groups.

When the user adds/modifies a rule, look at the relative score and potentially suggest a grouping.

In one embodiment, given the above process for identifying candidate new groups, the user is prompted to create a new group based on the process. However, the user can be prompted to create a new group for other processes that might be used to suggest new groups also.

1.4.4 Removing Principals from a List of Users and Groups

As shown in FIG. 5, one embodiment 500 of the access control management technique makes use of a minus sign operation 506 to visually indicate the removal of principals from a list of authorized users and groups. In addition one embodiment of the technique makes use of visual cues (e.g. strikethrough FIG. 5, 504) to indicate that a principal, while present in the list, will not actually have permission (as will occur when a minus sign later in the list removes the principal.)

1.4.5 Translation of Existing Access Control List Rules

One embodiment of the access control management technique provides a method for translating existing access control list rules into the list of principals representation paired with each resource/action pair. In one embodiment of the technique, this is done by setting the list of authorized principals to empty. Then, for each rule in the existing access control rules, from a lowest precedence to a highest precedence, and for each authorization explicitly authorized to a principal via the existing access control rules, the principal is added to the list of authorized principals for this resource/action pair, and for each authorization explicitly denied to a principal via the existing access control rules, the principal is added to the list of authorized principals for this resource/action pair using an exclusion operator (e.g., minus operator). An example of the logic used in one embodiment of the technique is as follows:

### Given:

A list of rules, each of which maps a single principal (user or group) to a set of permissions

### Want:

A map from permissions to a description of a group of principals, allowing exclusions of permissions from a principal (the minus sign).

### Starting State:

Set list of principals for each possible permission to empty.

For each rule in the list of rules from lowest precedence to highest precedence stated in form name ->(permissions rules), where name is the name of the principal.

For each permission explicitly granted to the principal via the rules Add principal to list of principals for this permission using inclusion (+) operator (“+ name”)

For each permission explicitly denied to the principal via the rules Add principal to list of principals for this permission using exclusion (−) operator (“− name”)

1.4.6 Verification of Permissions

One embodiment of the access control management technique provides a mechanism that allows the user to verify the permissions (granted or not) for a given principal. The mechanism provides a cue that illustrates the part of the policy in which the principal is either granted or denied permission. More specifically, as discussed previously in Section 1.4.1, in one embodiment, a user can use an input device such a keyboard to type a principal's name into a search box 414 to select a certain principal. Once a principal has been selected, an indicator, such as, for example, a check mark, 416 appears in the action entry for a row if the principal has permission to perform the action in the row. Another principal (e.g, an “X”) 418 appears if the principal does not have permission. A third indicator (e.g., a dash) appears if the principal is in a group and that principal is in the group descriptor but subject to some exclusions of authorizations.

1.4.7 Inherited and Custom Permission Presentation

One embodiment of the access control management technique provides for the presentation of inherited permissions inline with custom permissions, using formatting or indicator to differentiate file/folder-specific permissions from inherited permissions. More specifically, the access policy for a resource, such as, for example, a file, can be inherited from a folder or a level above the folder (e.g., a folder higher in the folder hierarchy). In one embodiment, the technique differentiates between authorizations that were specified by a user and those that were inherited based on the authorization level of a folder. The user can visually add and subtract authorized principals from a list of authorized principals for a resource/action pair by using plus and minus operators, as previously discussed. Principals whose permissions are inherited might be displayed in gray, while principals whose permissions are specified are displayed in a different color (e.g., black). In one embodiment, when a user chooses to edit the inherited permissions become a group named “Those allowed to <action name> <name of the parent object>”.

2.0 The Computing Environment

The access control management technique is designed to operate in a computing environment. The following description is intended to provide a brief, general description of a suitable computing environment in which the access control management technique can be implemented. The technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

FIG. 6 illustrates an example of a suitable computing system environment. The computing system environment is only one example of a suitable computing environment and is not intended to suggest any limitation as to the scope of use or functionality of the present technique. Neither should the computing environment be interpreted as having any dependency or requirement relating to any one or combination of components illustrated in the exemplary operating environment. With reference to FIG. 6, an exemplary system for implementing the access control management technique includes a computing device, such as computing device 600. In its most basic configuration, computing device 600 typically includes at least one processing unit 602 and memory 604. Depending on the exact configuration and type of computing device, memory 604 may be volatile (such as RAM), non-volatile (such as ROM, flash memory, etc.) or some combination of the two. This most basic configuration is illustrated in FIG. 6 by dashed line 606. Additionally, device 600 may also have additional features/functionality. For example, device 600 may also include additional storage (removable and/or non-removable) including, but not limited to, magnetic or optical disks or tape. Such additional storage is illustrated in FIG. 6 by removable storage 608 and non-removable storage 610. Computer storage media includes volatile and nonvolatile, removable and non-removable media implemented in any method or technology for storage of information such as computer readable instructions, data structures, program modules or other data. Memory 604, removable storage 608 and non-removable storage 610 are all examples of computer storage media. Computer storage media includes, but is not limited to, RAM, ROM, EEPROM, flash memory or other memory technology, CD-ROM, digital versatile disks (DVD) or other optical storage, magnetic cwebsitetes, magnetic tape, magnetic disk storage or other magnetic storage devices, or any other medium which can be used to store the desired information and which can accessed by device 600.

Device 600 also can contain communications connection(s) 612 that allow the device to communicate with other devices and networks. Communications connection(s) 612 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. The term computer readable media as used herein includes both storage media and communication media.

Device 600 may have various input device(s) 614 such as a display, keyboard, mouse, pen, camera, touch input device, and so on. Output device(s) 616 devices such as a display, speakers, a printer, and so on may also be included. All of these devices are well known in the art and need not be discussed at length here.

The access control management technique may be described in the general context of computer-executable instructions, such as program modules, being executed by a computing device. Generally, program modules include routines, programs, objects, components, data structures, and so on, that perform particular tasks or implement particular abstract data types. The access control management technique may be practiced in distributed computing environments where tasks are performed by remote processing devices that are linked through a communications network. In a distributed computing environment, program modules may be located in both local and remote computer storage media including memory storage devices.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

What is claimed is:

1. A computer-implemented process for managing access control to one or more resources, comprising:
using a computing device for:
mapping to each resource/action pair of a set of resource/action pairs a corresponding list of authorized principals that are authorized to perform the action on the resource; and
displaying names of the authorized principals mapped to each resource/action pair on a display device of the computing device.

2. The computer-implemented process of claim 1, further comprising displaying the name of each authorized principal in text form next to the corresponding resource/action pair on the display device.

3. The computer-implemented process of claim 1, further comprising using an in-line minus operator to visually indicate removal of authorization from one or more principals from the list of authorized principals.

4. The computer-implemented process of claim 1 wherein the list of authorized principals comprises users and groups of users authorized to perform the action on the resource of the corresponding resource/action pair.

5. The computer-implemented process of claim 4, further comprising displaying on the display device textual representations of authorized principals that expand and contract in line for as many levels are there are levels of groups of users.

6. The computer-implemented process of claim 1 further comprising displaying an editable text box to manage the list of authorized principals on the display device.

7. The computer-implemented process of claim 1, further comprising displaying on the display device a heuristic to encourage users to create new groups of authorized principals.

8. The computer-implemented process of claim 1, further comprising displaying a visual cue to indicate that an authorized principal, while present on the list of authorized principals, does not have authorization to perform an action on a corresponding resource.

9. The computer-implemented process of claim 8, wherein the visual cue is a strikethrough of the principal's name that does not have authorization to perform the action on a corresponding resource.

10. The computer-implemented process of claim 1, wherein an authorization to perform an action on a resource can be inherited or custom created.

11. The computer-implemented process of claim 10, wherein an indicator is used to indicate whether an authorization to perform an action is inherited or custom created.

12. The computer-implemented process of claim 11, wherein inherited and custom authorizations are displayed in a line on the display, and wherein inherited permissions are visually differentiated from custom authorization and are editable.

13. An access control management system for managing access control of one or more actions that a user is authorized to perform on a resource, comprising:
a general purpose computing device;
a computer program comprising program modules executable by the general purpose computing device, wherein the computing device is directed by upon execution of the program modules of the computer program to,
map to a resource/action pair a list of one or more authorized principals authorized to perform the corresponding action of the resource/action pair on the resource of the resource/action pair.

14. The access control management system of claim 13, further comprising a module to display each list of authorized principals next to the corresponding resource/action pair.

15. The access control management system of claim 13, further comprising a module to translate existing access control rules to create the list of authorized principals for each resource/action pair.

16. The access control management system of claim 15, wherein the module to translate existing access control rules to create the list of authorized principals for each resource/action pair further comprises sub-modules configured to, upon execution:
set the list of authorized principals to empty;
for each rule in the existing access control rules, from a lowest precedence to a highest precedence,
for each authorization explicitly authorized to a principal via the existing access control rules, add the principal to the list of authorized principals for this authorization, and
for each authorization explicitly denied to a principal via the existing access control rules, add the principal to the list of authorized principals for this authorization using an exclusion operator.

17. A computer-implemented process for managing access control to one or more resources, comprising:
using a computing device for:
mapping to each resource/role pair of a set of resource/role pairs, wherein a role further comprises a set of authorized actions, a list of the names of one or more authorized principals that are authorized to perform the corresponding set of authorized actions of the resource/role pair on the corresponding resource;
displaying the names of the authorized principals on the list of authorized principals next to the corresponding resource/role pairs on a display device of the computing device; and
allowing a user to manipulate the displayed names of authorized principals on the list of authorized principals mapped to each resource/role pair in order to manage the action authorization an authorized principal has on the corresponding resource.

18. The computer-implemented process of claim 17 wherein the resource comprises a file name or a directory name.

19. The computer-implemented process of claim 17 wherein the actions further comprise read, write and delete.

20. The computer-implemented process of claim 17 wherein the authorized principal is a user or a group of users.
